(19) United States
(12) Patent Application Publication
(10) Pub. No.: US 2011/0242330 A1
(43) Pub. Date: Oct. 6, 2011

(54) Apparatus, System and Method for Testing Broadcast Signals

(75) Inventors: Brian Petersson, Lockleys (AU); Carl Dempsey, Castro Valley, CA (US); John Giordano Giordano, Castro Valley, CA (US)

(73) Assignee: WOHLER TECHNOLOGIES, INC., Hayward, CA (US)

(21) Appl. No.: 12/751,451

(22) Filed: Mar. 31, 2010

(51) Int. Cl. H04N 17/00

(52) U.S. Cl. 348/180; 348/E17.001

(57) ABSTRACT

An apparatus, system and method that includes an enclosure having a front side and a back side. An input connection is joined to the enclosure for receiving an input signal having a format generally conforming to a one of a plurality of broadcast standards. At least one signal processor is within the enclosure for processing the input signal and for at least outputting parameters of the input signal. At least one personal audio-visual device is joined to the front side. The personal audio-visual device includes a display screen configurable for displaying at least one of the parameters.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to digital audio, digital video, and related data signals in the broadcast segment. More particularly, the invention relates to the testing of broadcast-ready digital or analog audio, digital or analog video, and related data signals.

### BACKGROUND OF THE INVENTION

Broadcast signals are distributed in various formats and include numerous attributes, including but not limited to video signals, audio signals and embedded data. Broadcasters and content generators need to access, review and assess numerous parameters associated with these attributes to ensure compliance with the relevant local and international broadcast standards and to confirm quality.

Additionally, broadcasters and content generators are faced with differing statutory regimes for broadcast signals in different countries and regions of the world that impose different and diverse quality tests. It is therefore an objective of the present invention to provide a low-cost (i.e., efficient), easily configurable and simple-to-use device with high functionality that can run various passive and active tests against broadcast signals.

Various test requirements call for access to different data points that are embedded in these signals such as, but not limited to, audio level and loudness values, audio phase information, multi-channel displays, sample rates, encoded bit streams, serial digital interface (SDI) displays, total harmonic distortion, video quality data, bit error rates, metadata, ancillary data, stream metadata, etc. Access to all such data points in a single enclosure can be very expensive, making it difficult for smaller content producers to afford the cost of purchase of required test equipment, while demand for specific data points in different enclosures may not be high enough to be commercially viable. Currently known testing devices are usually dedicated products that monitor a small subset of related data points inside a signal. It is difficult and cost-prohibitive to add additional data points as market requirements and market demand for access to the different embedded data points change. In recent times significant advances in technology coupled with the move to an all digital media environment has resulted in a new category of low cost pre and post production equipment capable of providing broadcast-ready signals that have a signal quality suitable for use by Broadcasters. This has resulted in a significant growth of small production facilities due to the affordability of modern acquisition and post production equipment. An area of concern to governing bodies responsible for standards applicable to the Broadcast industry is ensuring that program material produced by the smaller production facilities complies with the various standards for quality, signal integrity and levels for both audio and video. Current test and measurement equipment used by larger production facilities and broadcasters is still relatively expensive, often costing as much or more than the acquisition and editing equipment used by smaller production facilities.

In view of the foregoing, there is a need for innovative use of lower cost technologies for providing affordable devices for testing broadcast signals that enables a user to access multiple data points in a single enclosure.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary broadcast signal testing device using a personal audio-visual device, in accordance with an embodiment of the present invention;

FIG. 2 illustrates an exemplary broadcast signal testing device using a personal audio-visual device and remote communication port, in accordance with an embodiment of the present invention;

FIGS. 3A, 3B and 3C illustrate an exemplary broadcast signal testing device comprising multiple personal audio-visual devices, in accordance with an embodiment of the present invention. FIG. 3A is a front view; FIG. 3B is a rear view, and FIG. 3C is a cross sectional side view;

FIGS. 3D, 3E, 3F and 3G illustrate an exemplary view of personal audio-visual device 301, in accordance with an embodiment of the present invention. FIG. 3D is a front view. FIGS. 3E, 3F and 3G are edge views;

FIG. 4 illustrates a table of exemplary tests that may be enabled by an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, an apparatus, system and method for testing broadcast signals is presented.

In one embodiment an apparatus includes an enclosure including a front side and a back side, means for receiving an input signal having a format generally conforming to one of a plurality of standards, means for processing the input signal and for at least outputting parameters of the input signal and means for displaying at least one of the parameters. Another embodiment further includes means for outputting an output signal having a format generally conforming to one of a plurality of standards. Yet another embodiment further includes means for communicating the parameters to remote equipment. Still another embodiment further includes means for instructing the displaying means to communicate with the processing means to instruct the processing means to perform at least one test and further instruct the processing means to output test results in the parameters. Another embodiment further includes means for conveying an alarm through the displaying means. Yet another embodiment further includes means for energizing the apparatus and for maintaining a charge on a battery in the displaying means. Still another embodiment further includes an additional plurality of receiving means and outputting means, an additional plurality of configurable processing means and an additional plurality of displaying means. Another embodiment further includes an additional plurality of instructing means.

In another embodiment an apparatus includes an enclosure including a front side and a back side. An input connection is joined to the enclosure for receiving an input signal having a format generally conforming to one of a plurality of standards. At least one signal processor is within the enclosure for processing the input signal and for at least outputting parameters of the input signal. At least one personal audio-visual device is joined to the front side and includes a display screen configurable for displaying at least one of the parameters. Another embodiment further includes an output connection joined to the enclosure for outputting an output signal having a format generally conforming to one of a plurality of standards. Yet another embodiment further includes at least one port joined to the enclosure for communicating the parameters to remote equipment. Still another embodiment further includes a plurality of software modules stored in at least one audio-visual device for instructing at least one personal audio-visual device to communicate with at least one signal processor to instruct at least one signal processor to perform at least one test associated with a selected software module and further instruct at least one signal processor to output test results in the parameters. Another embodiment further includes configurable alarm states associated with at least one test for conveying an alarm through at least one personal audio-visual device. Yet another embodiment further includes a power source for energizing the apparatus and for maintaining a charge on a battery in at least one personal audio-visual device. In still another embodiment the output signal includes an edited version of the input signal output by the signal processor. In another embodiment at least one port communicates using a wired connection. In yet another embodiment the display screen is a touch screen for controlling at least one personal audio-visual device. In still another embodiment the touch screen enables the plurality of software modules to be selectively turned on and off. In another embodiment the plurality of standards is broadcast standards. Yet another embodiment further includes an additional plurality of input connections and output connections, an additional plurality of signal processors configurable as at least one signal processor and an additional plurality of personal audio-visual devices configurable as at least one personal audio-visual device. Still another embodiment further includes an additional plurality of software modules stored in the additional plurality of personal audio-visual devices. In another embodiment the enclosure is rack mountable.

In another embodiment a system includes an input signal having a format generally conforming to one of a plurality of standards. At least one signal processor processes the input signal and at least outputs parameters of the input signal. At least one personal audio-visual device includes a display screen configurable for displaying at least one of the parameters. Another embodiment further includes an output signal having a format generally conforming to one of a plurality of standards. Yet another embodiment further includes at least one port for communicating the parameters to remote equipment. Still another embodiment further includes a plurality of software modules stored in at least one audio-visual device for instructing at least one personal audio-visual device to communicate with at least one signal processor to instruct at least one signal processor to perform at least one test associated with a selected software module and further instruct at least one signal processor to output test results in the parameters. Another embodiment further includes configurable alarm states associated with at least one test for conveying an alarm through at least one personal audio-visual device. In yet another embodiment the output signal includes an edited version of the input signal. In still another embodiment at least one port communicates on a wireless connection. In another embodiment the display screen is a touch screen for controlling the personal audio-visual device. In yet another embodiment the touch screen enables the plurality of software modules to be selectively turned on and off. In still another embodiment the plurality of standards is broadcast standards. Another embodiment further includes an additional plurality of input signals and output connections, an additional plurality of signal processors configurable as at least one signal processor and a plurality of personal audio-visual devices configurable as at least one personal audio-visual device. Yet another embodiment further includes an additional plurality of software modules stored in the additional plurality of personal audio-visual devices.

In another embodiment a method includes steps of receiving an input signal having a format generally conforming to one of a plurality of standards, processing the input signal and at least outputting parameters of the input signal and displaying at least one of the parameters on a display screen of a personal audio-visual device. Another embodiment further includes the step of outputting an output signal having a format generally conforming to the one of a plurality of standards. Yet another embodiment further includes the step of communicating the parameters to remote equipment. Still another embodiment further includes the step of loading a plurality of software modules in the audio-visual device for instructions to perform at least one test associated with a selected software module and to output test results in the parameters. Another embodiment further includes the step of configuring alarm states associated with at least one test for conveying an alarm through at least one personal audio-visual device. In yet another embodiment the output signal includes an edited version of the input signal. In still another embodiment the step of communicating occurs on a wireless connection. In another embodiment the display screen is a touch screen for controlling the personal audio-visual device. Yet another embodiment further includes the step of using the touch screen to selectively turn on and off the plurality of software modules. In still another embodiment the plurality of standards is broadcast standards.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide methods, systems, and apparatuses including, but not limited to, computer program products and devices for performing passive and active tests, monitoring and editing against SMPTE240M, SMPTE 260M, SMPTE 274M, RP211, SMPTE 295M, SMPTE 296M, ITU-R BT.1120-7 HD formats and ITU-R BT.601-6, ITU-R BT.1358, ITU-R BT.656-5 SD formats transported over but not limited to the following interfaces (BP) SMPTE 297-2006 optical interface, Gigabit Ethernet (IEEE 802.3ab, IEEE 802.3z), PCI Express, serial digital interface (SDI) pursuant to SMPTE344M, SMPTE292M HD-SDI and SMPTE259M SD-SDI video interface standards, and AES signals pursuant to SMPTE 272M and SMPTE 299M audio standards or analog broadcast signals. Alternate embodiments of the present invention may be implemented to perform tests against various other signals such as, but not limited to, HD 720p H.264 BP, HD 1080i/p H.264 HP@L4, HD 1080i/p VC1/WMV9, HD 1080i/p MPEG-2 MP@HL, HD 1080i/p MPEG-4 ASP, and DivX.

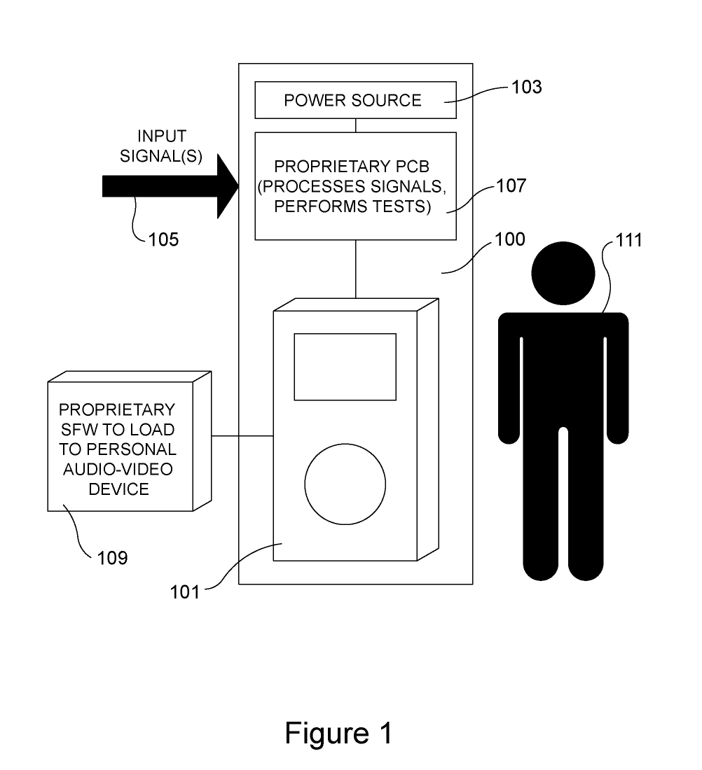

In some preferred embodiments, the tests are called via touch controls where such touch controls are managed by applications loaded onto one or more commercially available personal audio-visual devices such as, but not limited to, an iPod Touch® or a Creative Labs Zii system. Alternate embodiments may be implemented that do not use touch controls. The compact nature of the design of preferred embodiments is highly desirable in locations where space is at an absolute premium such as, but not limited to, broadcast stations, broadcast trucks, studios, etc. Furthermore, incorporating a personal audio-visual device into the testing device in preferred embodiments gives the device the advantage of having excellent graphical and intuitive operation capabilities that are typical of these personal audio-visual devices. FIG. 1 illustrates an exemplary broadcast signal testing device 100 using a personal audio-visual device 101, in accordance with an embodiment of the present invention. In the present embodiment, testing device 100 is self-contained, comprising a power source 103 and an input signal 105 to monitor and to process desired passive or active tests against, received through but not limited to, BNC 50 TO 75 ohm impedances, RCA, DVI-D, DVI-I, HDMI, SFP optical interface, USB-A, USB-B, USB Mini and Micro, USB Micro-AB Socket OTG, PCI Express and Gigabit Ethernet (IEEE 802.3ab, IEEE 802.3z, 1000BASE-LX10, 1000BASE-BX10), or other suitable connector, a printed circuit board (PCB) 107, personal audio-visual device 101, and a mechanical enclosure to hold all of the components. PCB 107 communicates to personal audio-visual device 101 via an integrated universal serial bus (USB) or other suitable port on personal audio-visual device 101. Input signals 105 may be in various different formats such as, but not limited to, SDI formats and standards pursuant to SMPTE292M HD-SDI, SMPTE259M SD-SDI standards, SMPTE240M, SMPTE 260M, SMPTE 274M, RP211, SMPTE 295M, SMPTE 296M, ITU-R BT.1120-7 HD formats, ITU-R BT.601-6, ITU-R BT.1358, ITU-R BT.656-5 SD formats, HD 720p H.264 BP, HD 1080i/p H.264 HP@L4, HD 1080i/p VC1/WMV9, HD 1080i/p MPEG-2 MP@HL, HD 1080i/p MPEG-4 ASP, DivX MPEG2 and MPEG4 based formats, SMPTE 297-2006 optical interface, SMPTE 272M and SMPTE 299M digital audio formats, and analog broadcast signals. Furthermore, different types of connectors may be used to provide the broadcast signal input in alternate embodiments, such as, but not limited to, BNC 50 TO 75 ohm impedances, RCA, DVI-D, DVI-I, HDMI, SFP optical interface, USB-A, USB-B, USB Mini and Micro, USB Micro-AB Socket OTG, PCI Express and Gigabit Ethernet (IEEE 802.3ab, IEEE 802.3z, 1000BASE-LX10, 1000BASE-BX10), etc. In the present embodiment, power source 103 may be a battery, an external power supply or other such power source that powers PCB 107. In the present embodiment, power source 103 also charges a battery within personal audio-visual device 101 via the USB port.

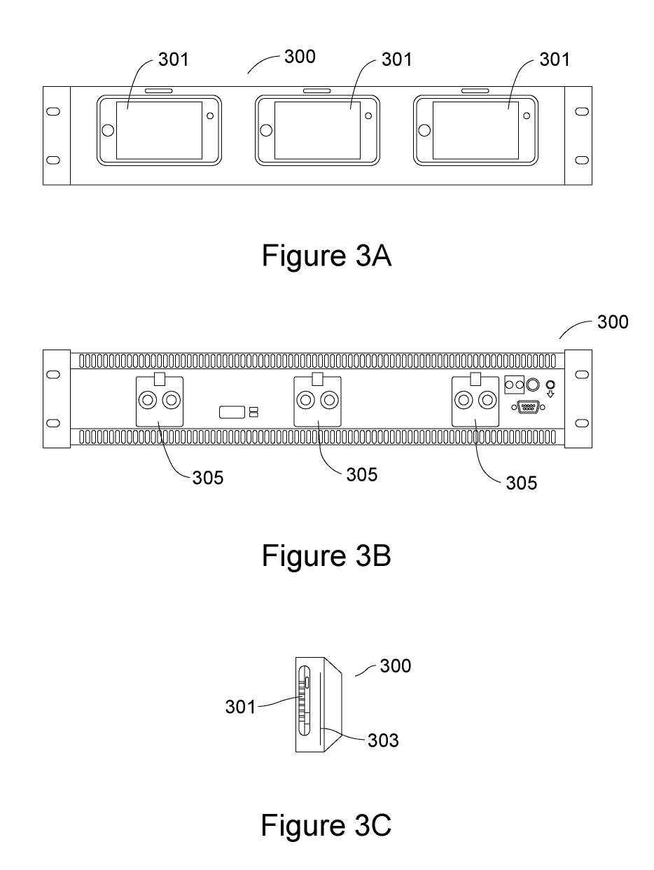

Testing device 100 takes input broadcast signal 105 in one or more signal formats, processes input signal 105 in PCB 107 and makes the results of that processing available to personal audio-visual device 101. In the present embodiment, personal audio-visual device 101 is a commercially available device such as, but not limited to, an iPod® that includes intuitive touch features or a cellular phone with touch features; however, personal audio-visual devices used in alternate embodiments may not have touch features. Other alternate embodiments may be implemented that incorporate audio-visual devices that are not commercially available, but are specifically designed for use with the testing device. Furthermore, multiple personal audio-visual devices may be used in some alternate embodiments, as shown by way of example in FIGS. 3A, 3B and 3C.

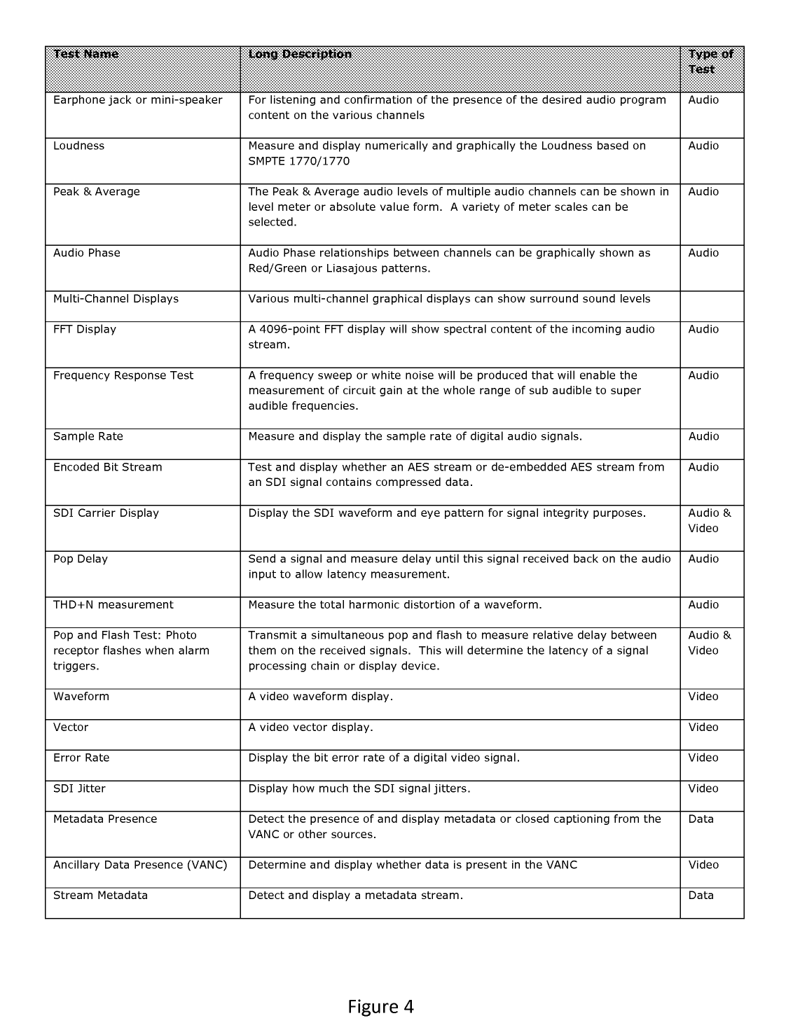

In the present embodiment, personal audio-visual device 101 is loaded with control software 109 to call the processed data via the integrated USB port for observation and manipulation. Software 109 comprises software modules, identified discretely or aggregately, that can be turned on or turned off. These software modules perform various tests on the data embedded in input signal 105. Some non-limiting examples of tests that may be performed on input signal 105 are identified in the table shown in FIG. 4. In the present embodiment, different sub-modules, coded in scalable VHDL (Very High Speed Integrated Circuits (VHSIC) Hardware Description Language) or in Verilog are loaded to PCB 107 with companion programs loaded onto personal audio-visual device 101. Since personal audio-visual device 101 becomes the universal window to a user 111, different sub-modules can be loaded or multiple sub-modules can be packaged together to keep the hardware unit volumes high while generally maintaining high customizability with the software sub-modules.

In typical use of the present embodiment, user 111 connects testing device 100 to input signal 105. This connection is made with a loop through connection when testing device 100 is in a testing or monitoring mode. This enables the broadcast signal to flow to other units in the broadcast facility. PCB 107 processes and performs tests on selected data elements embedded in or associated with input signal 105. In the present embodiment, PCB 107 is able to perform multiple tests in series or in parallel on input signal 105. The results of these tests are then called to personal audio-visual device 101 by software 109 installed on personal audio-visual device 101. These results are then displayed on personal audio-visual device 101 for user 111 to view. The present embodiment may also comprise configurable alarm states for the tests performed on input signal 105 that are communicated through the touch-screen and/or the related internal speaker of personal audio-visual device 101. For example only, but not intended to limit functionality, the alarm states may be configured to trigger when a test result is outside specified parameters, a loss of input signal, a failure in PCB 107, warning of near set limit based on broadcast industry standards relevant to signal type, statutory regime and format under test, etc. In other embodiments software 109, installed on personal audio-visual device 101, may include an expert system to aid a technician in diagnosing problems, such as, but not limited to, improperly terminated transmission lines, shorted or open output transmission lines, encoder overload, etc. In some preferred embodiments of the present invention, personal audio-visual device 101 may be used to edit and make changes to the input signal, for example, but not by way of limitation to, changes in audio loudness, summing and balance, and video chroma saturation, tint balance, black level, meta data associated with inputs being monitored and tested, video and audio format conversion for display on 101 LCD screen or scaled to lower resolution format using PCB 107 for output to a low cost external video monitor, not shown, etc. In the present invention, when the input signal is to be edited, PCB 107 breaks the loop through connection, provides proper termination to the input signal, and outputs the edited signal.

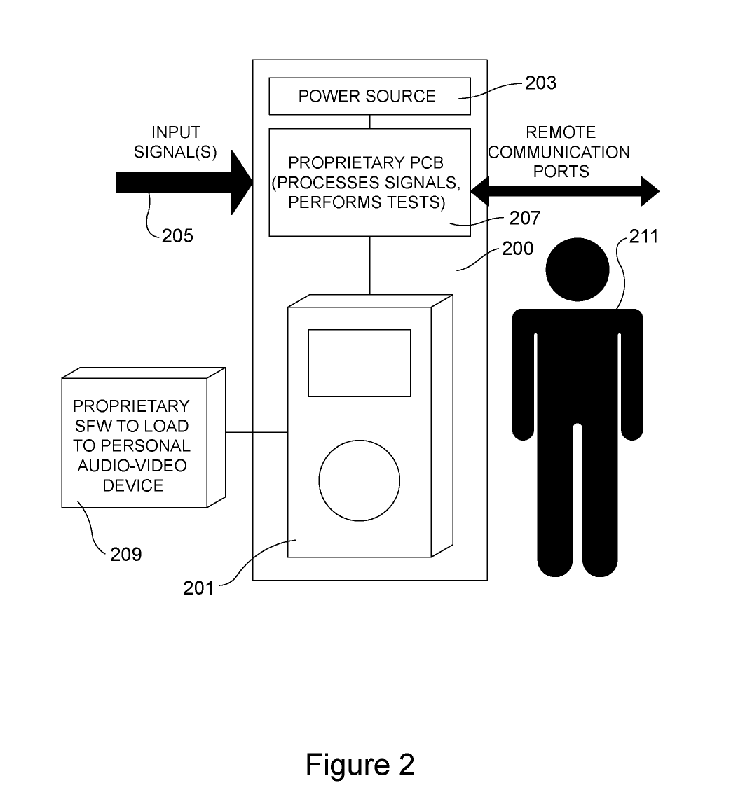

FIG. 2 illustrates an exemplary broadcast signal testing device 200 using a personal audio-visual device 201 and remote communication port, in accordance with an embodiment of the present invention. In the present embodiment, testing device 200 comprises personal audio-visual device 201 with control software 209 installed, a power source 203, and a PCB 207. PCB 207 processes and tests input signals 205 and sends the results to personal audio-visual device 201 via software 209 where a user 211 may view the results. In the present embodiment, the test parameters may be loaded onto PCB 207 remotely via bi-directional communication ports 213, which may include, but not be limited to, network interfaces, Ethernet interfaces or serial interfaces, from a 3^{rd} party device, etc. These test parameters may include, without limitation, input configuration for signal type, standards-based reference limits for device measurements, data for insertion or modification of meta data or signal under test, update of existing parameters. etc. The results of the tests may also be extracted and streamed through communication ports 213 and stored externally on a computing device or data storage means. In other embodiments communication ports 213 may communicate with other equipment in the broadcast facility such as, but not limited to, test signal generators, switchers or routers, etc. In doing so, software 209 may instruct a test signal generator to generate a specific test pattern or sequence and have that pattern or sequence routed to the broadcast signal testing device 200. In other embodiments, test results from audio-visual device 201, via PCB 207, and control of device 201 and PCB 207 may be streamed to and from a remote device such as, but not limited to, a computer used to edit video and audio content for remote viewing of signal status and control. In other embodiments, audio-visual device 201 may also communicate via wireless connection, not shown, in addition to wired communication port 213.

FIGS. 3A, 3B and 3C illustrate an exemplary broadcast signal testing device 300 comprising multiple personal audio-visual devices 301, in accordance with an embodiment of the present invention. FIG. 3A is a front view; FIG. 3B is a rear view, and FIG. 3C is a cross sectional side view. In the present embodiment testing device 300 comprises personal audio-visual devices 301, PCBs 307 and signal input interfaces 335. In an embodiment of the present invention, testing device 300 is dimensioned as a 2 standard Rack Unit (2RU) and may be rack-mounted with like units to enable optimal use of space in the broadcast facility. Up to 3 personal audio-visual devices 301 may be enclosed in the 2RU rack mount enclosure that can provide a technician the ability to monitor a minimum of 3 different signals simultaneously or 3 or more data elements of a single signal simultaneously on separate screens. Testing device 300 enables the ability to switch between multiple signal types such as, but not limited to, SDI, AES, Analog, etc. for monitoring, testing or editing. In one embodiment, a signal type selection may be made using personal audio-visual device 301. In another embodiment, signal type selection may be automatically made by PCB 307 sensing the input type. In FIG. 3A, personal audio-visual devices 301 are mounted on the face of the rack mount for testing device 300. Devices 301 are retained inside the enclosure by means of enclosure bracket 320 which holds personal audio-visual devices 301 in place. Those skilled in the art will readily recognize that a plurality of alternate means for retaining may be used to retain personal audio-visual devices 301 in place. In some embodiments, memory slots 330 may be provided on testing device 300. Memory slots 330 are configurable to accept a variety of memory cards or flash drives. In some embodiments, test results can be stored on a memory card inserted in memory slot 330. This enables unattended testing/monitoring where a technician may periodically remove the memory card and view and or analyze the test results on a personal computing device. In other embodiments, the memory card may be used to transfer software to the personal audio-visual devices 301. In other embodiments, the memory card may be used to transfer test parameters to the PCBs 307.

FIG. 3B illustrates a typical back panel for testing device 300 in accordance with an embodiment of the present invention. In this embodiment, there is a signal input interface 335 associated with each personal audio-visual device 301. Alternate embodiments may have fewer or more signal input interfaces 335. In the present embodiment, signal input interface comprises a signal IN 350 and a signal OUT 345. Typically, when personal audio-visual device 301 is in a testing or monitoring mode, the input signal from the broadcast facility is connected to signal IN 350 that is looped through to signal OUT 345 to be passed to other devices in the facility. When personal audio-visual device 301 is in an editing mode, PCB properly terminates the signal on signal IN 350 and outputs an edited signal on signal OUT 345. One skilled in the art will readily recognize that numerous signal connections are possible, such as, but not limited to, one input signal looped through all of the signal input interfaces 335, two input signals or three input signals, etc. Power connection 303 connects to an external power source that can directly supply power to the personal audio-visual devices 301 and PCBs 307. In an alternate embodiment, power connection 303 may be configured to accept an AC power source or other DC sources and an internal power converter, not shown, would convert the external power source to be compatible with the personal audio-visual devices 301 and PCBs 307. In the present invention, communication port 355 enables testing device 300 to communicate with external devices to, for example, but not by way of limitation, download software for the personal audio-visual devices 301 and PCBs 307, stream test results to external devices, control test signal generators, switcher or routers, etc.

FIG. 3C illustrates a cross sectional side view of test device 300 in accordance with an embodiment of the present invention. Personal audio-visual device 301 is mounted in front of the associated PCB 307. In alternate embodiments, the personal audio-visual device 301 may have one or more associated additional PCBs 310. In some of these embodiments, the additional PCBs may share the same input signal. In other embodiments, additional signal IN 350 and a signal OUT 345 connections may be provided.

FIGS. 3D, 3E, 3F and 3G illustrate an exemplary view of personal audio-visual device 301, in accordance with an embodiment of the present invention. FIG. 3D is a front view. FIGS. 3E, 3F and 3G are edge views. In FIG. 3E, a universal serial bus (USB) connects the personal audio-visual device 301 to an associated PCB 307 via a cable. The cable has a sufficient length to enable operation of the personal audio-visual device 301 when it is removed from the face of testing device 300. In the present invention, personal audio-visual devices 301 are iPod Touch devices; however, different types of personal audio-visual devices may be used in alternate embodiments such as, but not limited to, other types of iPods, MP3 players, cellular phones, netbooks, etc.

FIG. 4 illustrates a table of exemplary tests that may be enabled by an embodiment of the present invention. Those skilled in the art will readily recognize that this table only represents a portion of the various tests that one would conceive to support the assessment and testing of the multitude of signals types to the multitude of standards formats encountered in a broadcast facility. Embodiments of the present invention are contemplated as being enabled for testing all present and future broadcast signal standards.

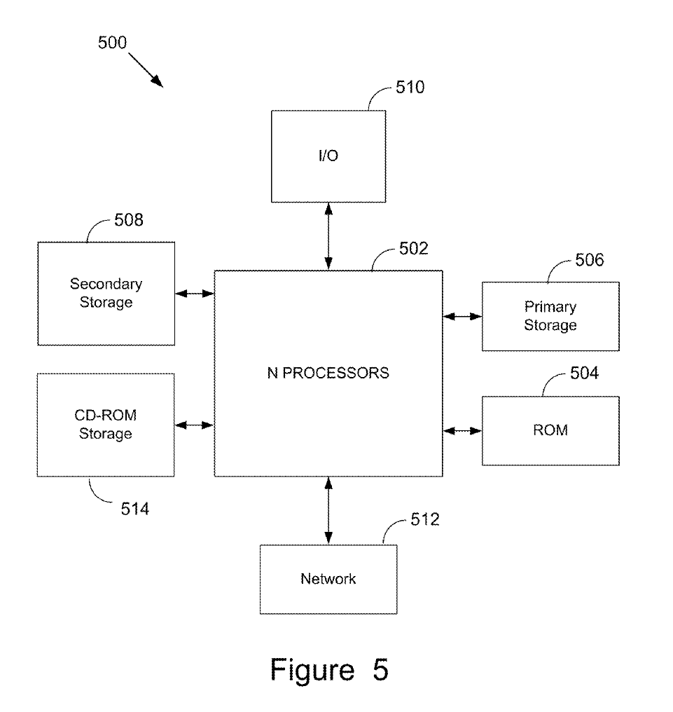

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

A basic testing device according to some preferred embodiments of the present invention comprises a single PCB mounted behind a single personal audio-visual device with a single signal input, which provides access to one data point at a time. However, those skilled in the art, in light of the present teachings, will readily recognize that alternate embodiments of the present invention may be more complex and implemented with various different combinations of signal inputs, multiple PCBs, multiple tests, multiple alarms, expert systems for diagnostics, editing of the input and transmitting the edited signal, storage of test results and output communications to various devices.

One alternate embodiment is a device with a single signal input, either SDI, or AES or Analog, that performs a single test. This device has no output communications through a remote communication port and receives no remote test parameters. Another alternate embodiment is a device with multiple signal inputs, SDI, AES or Analog, that performs a single test visible on the interface and has no output communications through a remote communication port and no receipt of remote test parameters. Yet another alternate embodiment comprises multiple signal inputs and performs a single test where the results of the test are both visible on the interface and communicated externally via a remote communication port while not receiving remote test parameters. Yet another alternate embodiment comprises multiple signal inputs and performs a single test, the results of which are both visible on the interface and communicated externally via a remote communication port, and receives remote test parameters for the display of the test results.

Other alternate embodiments may be implemented to perform multiple tests. In one such alternate embodiment, the device has a single signal input, SDI, AES or Analog, and performs any one of a number of tests that are visible on the interface and has no output communications through a remote communication port and no receipt of remote test parameters. Another alternate multiple test embodiment comprises multiple signal inputs, SDI, AES or Analog, and performs any one of a number of tests that are visible on the interface, either simultaneously or in serial fashion depending on space requirements to display the assessment criteria, with no output communications through a remote communication port and no receipt of remote test parameters. In yet another alternate multiple test embodiment, a device comprises multiple signal inputs and performs any one of a number of tests, the results of which are visible on the interface, either simultaneously or in serial fashion depending on space requirements to display the assessment criteria, and are communicated externally via a remote communication port, with no receipt of remote test parameters. Yet another alternate multiple test embodiment comprises multiple signal inputs and performs any one of a number of tests, the results of which are visible on the interface, either simultaneously or in serial fashion depending on space requirements to display the assessment criteria, and are communicated externally via a remote communication port, while receiving remote test parameters for display of test results.

Having fully described at least one embodiment of the present invention, other equivalent or alternative methods of providing a broadcast signal testing system according to the present invention will be apparent to those skilled in the art. The invention has been described above by way of illustration, and the specific embodiments disclosed are not intended to limit the invention to the particular forms disclosed. For example, the particular implementation of the testing device may vary depending upon the particular type of signal being tested. The testing devices described in the foregoing were directed to implementations for testing broadcast signals; however, similar techniques are to provide testing devices for other types of signals such as, but not limited to, text-based data. Non-broadcast implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
an enclosure comprising a front side and a back side;
means for receiving an input signal having a format generally conforming to a one of a plurality of standards;
means for processing said input signal and for at least outputting parameters of said input signal; and
means for displaying at least one of said parameters.

2. The apparatus as recited in claim 1, further comprising means for outputting an output signal having a format generally conforming to said one of a plurality of standards.

3. The apparatus as recited in claim 1, further comprising means for communicating said parameters to remote equipment.

4. The apparatus as recited in claim 1, further comprising means for instructing said displaying means to communicate with said processing means to instruct said processing means to perform at least one test and further instruct said processing means to output test results in said parameters.

5. The apparatus as recited in claim 1, further comprising means for conveying an alarm through said displaying means.

6. The apparatus as recited in claim 1, further comprising means for energizing the apparatus and for maintaining a charge on a battery in said displaying means.

7. The apparatus as recited in claim 4, further comprising an additional plurality of receiving means and outputting means, an additional plurality of processing means configurable as said processing means and an additional plurality of displaying means configurable as said displaying means.

8. The apparatus as recited in claim 7, further comprising an additional plurality of instructing means.

9. An apparatus comprising:
an enclosure comprising a front side and a back side;
an input connection joined to said enclosure for receiving an input signal having a format generally conforming to a one of a plurality of standards;
at least one signal processor within said enclosure for processing said input signal and for at least outputting parameters of said input signal; and
at least one personal audio-visual device joined to said front side and comprising a display screen configurable for displaying at least one of said parameters.

10. The apparatus as recited in claim 9, further comprising an output connection joined to said enclosure for outputting an output signal having a format generally conforming to said one of a plurality of standards.

11. The apparatus as recited in claim 9, further comprising at least one port joined to said enclosure for communicating said parameters to remote equipment.

12. The apparatus as recited in claim 9, further comprising a plurality of software modules stored in said at least one audio-visual device for instructing said at least one personal audio-visual device to communicate with said at least one signal processor to instruct said at least one signal processor to perform at least one test associated with a selected software module and further instruct said at least one signal processor to output test results in said parameters.

13. The apparatus as recited in claim 12, further comprising configurable alarm states associated with said at least one test for conveying an alarm through said at least one personal audio-visual device.

14. The apparatus as recited in claim 9, further comprising a power source for energizing the apparatus and for maintaining a charge on a battery in said at least one personal audio-visual device.

15. The apparatus as recited in claim 10, wherein said output signal comprises an edited version of said input signal output by said signal processor.

16. The apparatus as recited in claim 11, wherein said at least one port communicates using a wired connection.

17. The apparatus as recited in claim 9, wherein said display screen is a touch screen for controlling said at least one personal audio-visual device.

18. The apparatus as recited in claim 17, wherein said touch screen enables said plurality of software modules to be selectively turned on and off.

19. The apparatus as recited in claim 9, wherein said plurality of standards is broadcast standards.

20. The apparatus as recited in claim 12, further comprising an additional plurality of input connections and output connections, an additional plurality of signal processors configurable as said at least one signal processor and an additional plurality of personal audio-visual devices configurable as said at least one personal audio-visual device.

21. The apparatus as recited in claim 20, further comprising an additional plurality of software modules stored in said additional plurality of personal audio-visual devices.

22. The apparatus as recited in claim 9, wherein said enclosure is rack mountable.

23. A system comprising:
an input signal having a format generally conforming to a one of a plurality of standards;
at least one signal processor for processing said input signal and for at least outputting parameters of said input signal; and
at least one personal audio-visual device comprising a display screen configurable for displaying at least one of said parameters.

24. The system as recited in claim 23, further comprising an output signal having a format generally conforming to said one of a plurality of standards.

25. The system as recited in claim 23, further comprising at least one port for communicating said parameters to remote equipment.

26. The system as recited in claim 23, further comprising a plurality of software modules stored in said at least one audio-visual device for instructing said at least one personal audio-visual device to communicate with said at least one signal processor to instruct said at least one signal processor to perform at least one test associated with a selected software module and further instruct said at least one signal processor to output test results in said parameters.

27. The system as recited in claim 26, further comprising configurable alarm states associated with said at least one test for conveying an alarm through said at least one personal audio-visual device.

28. The system as recited in claim 24, wherein said output signal comprises an edited version of said input signal.

29. The system as recited in claim 25, wherein said at least one port communicates on a wireless connection.

30. The system as recited in claim 23, wherein said display screen is a touch screen for controlling said personal audio-visual device.

31. The system as recited in claim 30, wherein said touch screen enables said plurality of software modules to be selectively turned on and off.

32. The system as recited in claim 23, wherein said plurality of standards is broadcast standards.

33. The system as recited in claim 26, further comprising an additional plurality of input signals and output connections, an additional plurality of signal processors configurable as said at least one signal processor and a plurality of personal audio-visual devices configurable as said at least one personal audio-visual device.

34. The system as recited in claim 33, further comprising an additional plurality of software modules stored in said additional plurality of personal audio-visual devices.

35. A method comprising steps of:
receiving an input signal having a format generally conforming to a one of a plurality of standards;
processing said input signal and at least outputting parameters of said input signal; and
displaying at least one of said parameters on a display screen of a personal audio-visual device.

36. The method as recited in claim 35, further comprising the step of outputting an output signal having a format generally conforming to said one of a plurality of standards.

37. The method as recited in claim 35, further comprising the step of communicating said parameters to remote equipment.

38. The method as recited in claim 35, further comprising the step of loading a plurality of software modules in said audio-visual device for instructions to perform at least one test associated with a selected software module and to output test results in said parameters.

39. The method as recited in claim 38, further comprising the step of configuring alarm states associated with said at least one test for conveying an alarm through said at least one personal audio-visual device.

40. The method as recited in claim 36, wherein said output signal comprises an edited version of said input signal.

41. The method as recited in claim 37, wherein said step of communicating communicates on a wireless connection.

42. The method as recited in claim 35, wherein said display screen is a touch screen for controlling said personal audio-visual device.

43. The method as recited in claim 42, further comprising the step of using said touch screen to selectively turn on and off said plurality of software modules.

44. The method as recited in claim 35, wherein said plurality of standards is broadcast standards.
